(19) United States
(12) Patent Application Publication
(10) Pub. No.: US 2024/0158203 A1
(43) Pub. Date: May 16, 2024

(54) INFORMATION PROCESSING APPARATUS, INFORMATION PROCESSING METHOD, AND NON-TRANSITORY COMPUTER READABLE MEDIUM

(71) Applicant: KABUSHIKI KAISHA TOSHIBA, Tokyo (JP)

(72) Inventors: Ken UENO, Tokyo (JP); Akihiro YAMAGUCHI, Tokyo (JP)

(73) Assignee: KABUSHIKI KAISHA TOSHIBA, Tokyo (JP)

(21) Appl. No.: 18/466,064

(22) Filed: Sep. 13, 2023

(30) Foreign Application Priority Data
Nov. 14, 2022 (JP) 2022-182021

(51) Int. Cl. B66B 5/00

(52) U.S. Cl. CPC B66B 5/0018

(57) ABSTRACT

According to one embodiment, an information processing apparatus includes processing circuitry configured to acquire transition data representing a transition of a plurality of operations of a monitoring object, divide, based the transition data, a first waveform of a sensor with respect to the monitoring object into a plurality of sections corresponding to the plurality of operations, and generate a first estimation model related to a state of the monitoring object based on partial waveforms of the plurality of sections in the first waveform.

### CROSS REFERENCE TO RELATED APPLICATIONS

This application is based upon and claims the benefit of priority from the prior Japanese Patent Application No. 2022-182021, filed on Nov. 14, 2022, the entire contents of which are incorporated herein by reference.

### FIELD

Embodiments described herein relate to an information processing apparatus, an information processing method, and a non-transitory computer readable medium.

### BACKGROUND

In maintenance of a facility, a waveform indicating behavior of the facility (monitoring object) is acquired by a sensor or the like and when the waveform includes an anomaly or a sign of an occurrence of an anomaly (anomaly sign) of the facility, measures are taken before the anomaly spreads or occurs to prevent the facility from becoming dysfunctional. In doing so, a waveform pattern (normal waveform pattern) indicating behavior unique to the facility in a normal state is generated in advance and detection of an anomaly or an anomaly sign is performed by collating the waveform pattern with a waveform indicating behavior of the facility during normal operation. Being unable to generate an appropriate normal waveform pattern may possibly lead to falsely detecting an anomaly or an anomaly sign despite the facility operating normally.

When maintaining a large number of facilities, since preparing the same number of sensors as the facilities and installing the sensors in all facilities is desirable but inevitably increases cost, inexpensive and simple sensors are desirably used. However, inexpensive sensors offer low performance and detected waveforms are prone to fluctuations. Therefore, generating an appropriate normal waveform pattern requires a larger number of pieces of data for learning (training waveforms).

In addition, some facilities may include an operation with a low frequency of occurrence and random timings of occurrence such as when making an emergency stop under predetermined conditions, and a training waveform that includes such an operation prevents learning from being performed appropriately and makes it difficult to generate a normal waveform pattern.

### BRIEF DESCRIPTION OF THE DRAWINGS

FIG. 1 is a block diagram showing an information processing system according to a first embodiment;

FIG. 2 is a diagram showing an example of a normal waveform;

FIG. 3 is a diagram showing an example of a normal waveform after waveform preprocessing;

FIG. 4 is a diagram illustrating processing performed by a waveform segmentation device;

FIG. 5 is a diagram showing an example of transition data;

FIG. 6 is a diagram showing another expression of transition data;

FIG. 7 is a diagram showing an example of a transition graph;

FIG. 8 is a diagram showing a training waveform divided based on a transition graph;

FIG. 9 is a diagram showing an object section candidate;

FIG. 10 is a diagram showing an example of a normal waveform pattern;

FIG. 11 is a flow chart of processing during learning by an information processing apparatus according to the first embodiment;

FIG. 12 is a diagram showing an example of processing performed by a score calculator;

FIG. 13 is a flow chart of processing during a diagnosis by the information processing apparatus according to the first embodiment;

FIG. 14 is a diagram showing an example of transition data that takes a restart operation into consideration;

FIG. 15 is a diagram showing another expression of transition data that takes a restart operation into consideration;

FIG. 16 is a diagram showing an example of a transition graph that takes a restart operation into consideration;

FIG. 17 is a diagram showing a training waveform divided based on a transition graph that takes a restart operation into consideration;

FIG. 18 is a block diagram showing an information processing system according to a second embodiment;

FIG. 19 is a flow chart of processing during learning by an information processing apparatus according to the second embodiment;

FIG. 20 is a block diagram showing an information processing system according to a third embodiment;

FIG. 21 is a flow chart of processing during learning by an information processing apparatus according to the third embodiment; and

FIG. 22 is a diagram showing a hardware configuration of an information processing apparatus according to each embodiment.

### DETAILED DESCRIPTION

According to one embodiment, an information processing apparatus includes processing circuitry configured to acquire transition data representing a transition of a plurality of operations of a monitoring object, divide, based the transition data, a first waveform of a sensor with respect to the monitoring object into a plurality of sections corresponding to the plurality of operations, and generate a first estimation model related to a state of the monitoring object based on partial waveforms of the plurality of sections in the first waveform.

Hereinafter, embodiments of the present invention will be described with reference to the drawings.

### First Embodiment

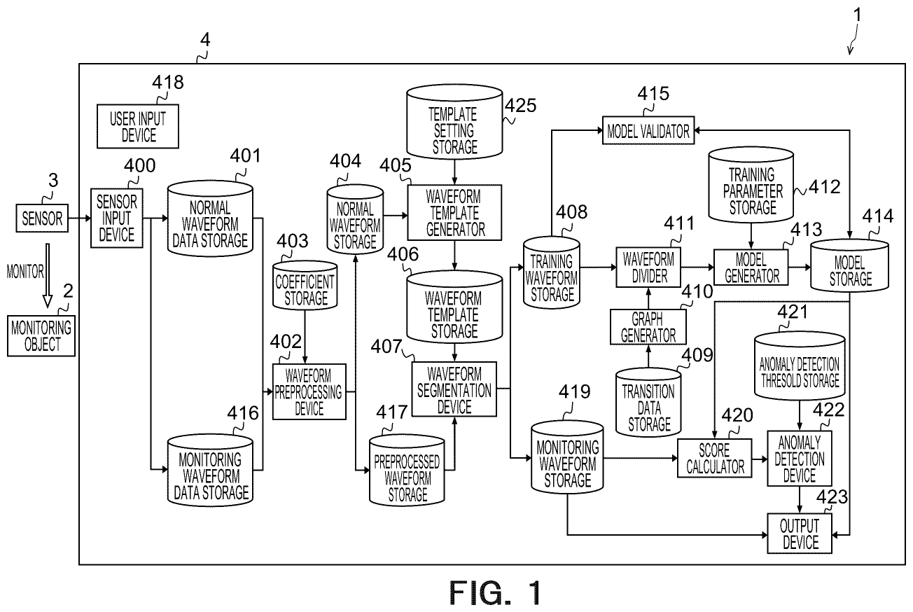

FIG. 1 is a block diagram showing an example of an information processing system 1 according to a first embodiment. The information processing system 1 includes a monitoring object 2, a sensor 3, and an information processing apparatus 4. The information processing system 1 is a system that detects, based on transition data representing a transition of operations related to the monitoring object 2, a state of the monitoring object 2 or, more specifically, an anomaly or a sign of an anomaly that may occur in the monitoring object 2.

While the monitoring object 2 is not particularly limited, in each present embodiment described below, the monitoring object 2 may be explained as an elevator door and the monitoring object 2 may be described as an elevator door 2. The monitoring object 2 is not limited to an elevator door and may be a device with a predetermined operation pattern such as an automatic door, a belt conveyor, and a carrier roller. In addition, although not illustrated, an elevator normally opens and closes by causing a door of the elevator itself (car) and a door of a building in which the elevator is installed to engage with each other. Hereinafter, it is assumed that an elevator door includes both the door of the car and the door of the building that are being engaged with each other.

The sensor 3 measures a value (waveform) of one or more predetermined items to be monitored related to an operation of the monitoring object 2. The sensor 3 may be built into the monitoring object 2 or may be installed outside of the monitoring object 2. The sensor 3 may be a sensor that can be installed by being retro-fitted to the monitoring object 2. Hereinafter, the sensor 3 is assumed to be a current sensor (a clamp-on current probe) for measuring a current waveform of a motor that opens and closes the elevator door 2. When using a clamp-on current probe as the sensor 3, since the monitoring object 2 need not be modified and wire connections of a control panel or the like are not required, a risk of affecting the existing monitoring object 2 is low.

The sensor described above is merely an example of the sensor 3 and, for example, the sensor 3 may be a sensor that detects vibration, pressure, sound, light, velocity, acceleration, tilt, or the like of the monitoring object 2. The sensor 3 may be provided in plurality. The item to be monitored may be obtained from measured values of a plurality of sensors 3.

The information processing apparatus 4 includes a sensor input device 400, a normal waveform data storage 401, a waveform preprocessing device 402, a coefficient storage 403, a normal waveform storage 404, a waveform template generator 405, a waveform template storage 406, a waveform segmentation device 407, a training waveform storage 408, a transition data storage 409, a graph generator 410, a waveform divider 411, a training parameter storage 412, a model generator 413, a model storage 414, a model validator 415, a monitoring waveform data storage 416, a preprocessed monitoring waveform storage 417, a user input device 418, a monitoring waveform storage 419, a score calculator 420, a detection threshold storage 421, a state judgement device 422, an output device 423, and a template setting storage 425. At least one of the waveform preprocessing device 402, the waveform template generator 405, the waveform segmentation device 407, the waveform divider 411, the graph generator 410, the model generator 413, the model validator 415, the score calculator 420, and the state judgement device 422 corresponds to processing circuitry or a processing circuit that performs processing related to the present embodiment.

First, during learning, the information processing apparatus 4 generates a normal waveform pattern from a waveform (normal waveform) indicating an operation of a monitoring object 2 or a device included in the monitoring object 2 in a normal state. A normal waveform pattern refers to a pattern of a waveform pattern that is unique to the monitoring object 2 in the normal state. A normal waveform pattern may be paraphrased as an extracted feature of a normal waveform.

Next, during a diagnosis, the information processing apparatus 4 measures a waveform (monitoring waveform) indicating an operation of the monitoring object 2 in an unknown state. The information processing apparatus 4 collates the monitoring waveform and the normal waveform pattern with each other and issues a warning when the monitoring waveform deviates from the normal waveform pattern (when the information processing apparatus 4 determines that the monitoring object 2 is not in a normal state). When a warning is issued, a user can recognize a possibility that an anomaly or an anomaly sign has occurred in the door of the car and/or the door of the building. Since an accuracy of a state detection of the monitoring object 2 depends on the normal waveform pattern, generating an appropriate normal waveform pattern is important. When an anomaly is detected, the information processing apparatus 4 may control an operation of the monitoring object 2. For example, the operation of the monitoring object 2 may be stopped or an operating mode of the monitoring object 2 may be changed (for example, from a normal mode to a safety mode). In addition, an output device such as a indicator included in the monitoring object 2 may be caused to output information indicating that an anomaly has been detected.

First, processing of the information processing apparatus 4 during learning will be described.

The user input device 418 receives input of various parameters and settings by the user.

The sensor input device 400 acquires numerical value data of a normal waveform (normal waveform data) acquired by the sensor 3 and stores the normal waveform data in the normal waveform data storage 401.

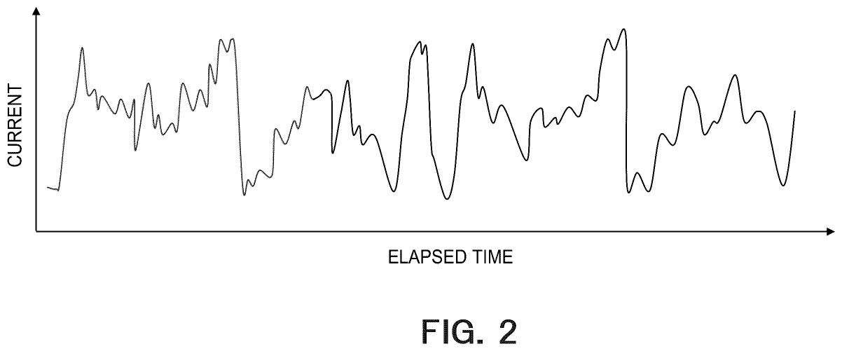

FIG. 2 is a diagram showing an example of normal waveform data.

For example, normal waveform data is acquired during maintenance checkup of the monitoring object 2. Normal waveform data is data including a fluctuation in a current value of the motor when, for example, the elevator door 2 consecutively opens and closes a plurality of times. The normal waveform data storage 401 may store information such as how many times the monitoring object 2 had operated (how many times the elevator door opened and closed) during acquisition of normal waveform data. The normal waveform data storage 401 may store normal waveform data acquired during maintenance checkups in the past.

The waveform preprocessing device 402 performs waveform preprocessing of normal waveform data. Waveform preprocessing is performed for the purpose of denoising of normal waveform data and the like. Waveform preprocessing includes processing of applying a low-pass filter while moving a window function by constant time widths with respect to the normal waveform data. Waveform preprocessing may include processing of removing an outlier from the normal waveform data.

Although a low-pass filter based on a window function is assumed, the use of a low-pass filter that does not use a window function is not excluded.

As the window function, any window function such as a Hanning window (Hann window), a Hamming window, or a Blackman window may be used. For example, a Hanning window function w(t) is expressed as w(t)=0.5−0.5 cos (2πt/T) (0≤t≤T, where T is a constant).

A transfer function H(s) of a low-pass filter is expressed as, for example, H(s)=K/(1+sτ) (where K denotes a gain coefficient and τ denotes a time constant). For example, a low-pass filter using a moving average method, Gaussian convolution, or a first-order lag system may be used as the low-pass filter.

The coefficient storage 403 stores coefficients (constants and parameters) of the window function used in waveform preprocessing and coefficients included in a function of the low-pass filter and the like.

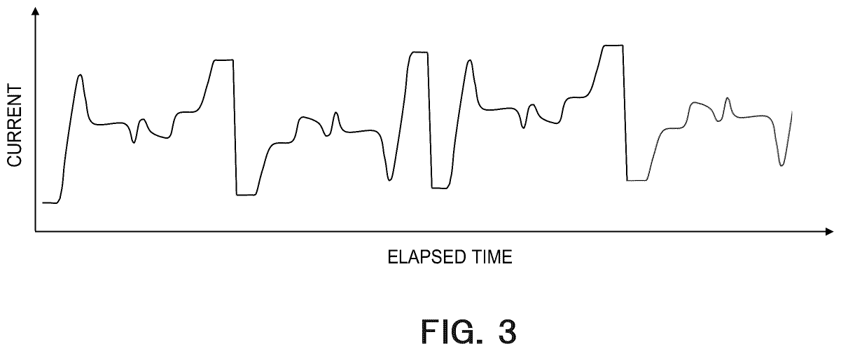

FIG. 3 is a diagram showing an example of a normal waveform after waveform preprocessing.

The normal waveform storage 404 stores a normal waveform after waveform preprocessing. The normal waveform storage 404 may store a normal waveform after waveform preprocessing acquired during maintenance checkups in the past.

The waveform template generator 405 generates a waveform template of an operation pattern of the monitoring object 2 from the normal waveform after waveform preprocessing and stores the generated waveform template in the waveform template storage 406. Examples of the waveform template include a waveform template of a door opening operation and a waveform template of a door closing operation of the elevator door 2. The waveform template is used to segment a partial waveform for learning (a training waveform or a first waveform) that corresponds to the operation pattern described above from the normal waveform.

The waveform template generator 405 may detect a start of an operation (for example, door opening or door closing) in a normal waveform after waveform preprocessing and adopt, as a waveform template, a partial waveform (start partial waveform X) with a certain time length that is shorter than a length of an operation pattern expected from a time of day of the detected start and information (time section information Y) that specifies a time section from the start to an end of the operation.

A detection that a door closing operation has occurred is made when a gradient of a current with a value equal to or lower than a predetermined value changes from 0 to a gradient equal to or larger than a certain value and the current value reaches or exceeds a threshold within a threshold time period. In this case, a partial waveform with a time length determined in advance from a time of day t1 at which the gradient changes from 0 is considered the start partial waveform X. In addition, a range of a predetermined time length from the time of day t1 at which the gradient changes from 0 is considered the time section information Y. Alternatively, a time length from the time of day t1 to a time of day t2 which is later than the time of day t1, at which the current value is equal to or lower than a predetermined value, and at which the gradient is 0 may be considered the time section information Y.

A section length indicated by the time section information Y corresponds to, for example, a period of time required by the elevator door 2 to open or close once or to any longer period of time.

A method of determining the start partial waveform X and the time section information Y described above is merely an example, and any detection method can be defined for each operation pattern. For example, the user may designate the start partial waveform X and the time section information Y.

Alternatively, a waveform template may be solely constituted of the partial waveform X as a beginning part, and the time section information Y need not be defined. In this case, time section information is dynamically determined when segmenting a training waveform corresponding to the operation pattern from the normal waveform. For example, a time at an end of the segmented partial waveform (an end time of an operation) is detected based on a change in the gradient of a current value or the like and a period from a time of a beginning to the detected time of the end of the segmented partial waveform is handled as time section information.

The template setting storage 425 stores a waveform template generated for each operation pattern by the waveform template generator 405.

The waveform template generator 405 generates as many waveform templates as the number of types of operation patterns to be performed by the monitoring object 2. For example, when the monitoring object 2 is an elevator door, the waveform template generator 405 respectively generates a waveform template for during door opening and for during door closing.

The waveform segmentation device 407 segments a training waveform of each single door opening operation and each single door closing operation using waveform templates from the normal waveform after waveform preprocessing.

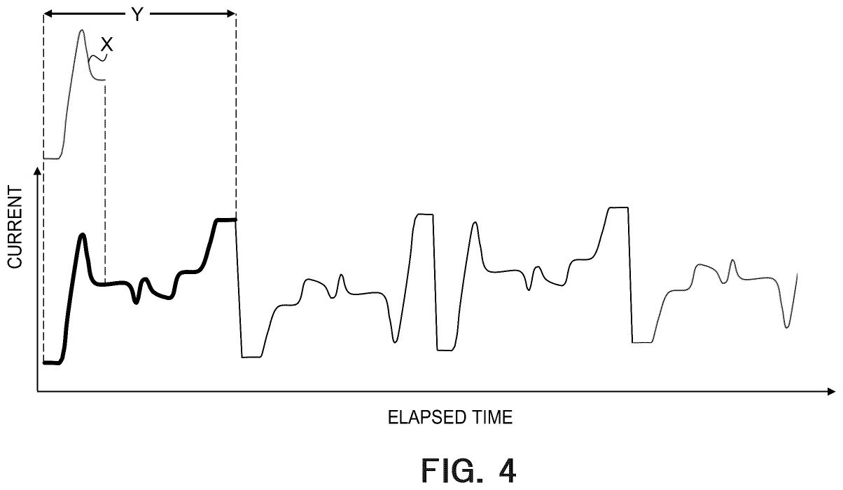

FIG. 4 is a diagram illustrating waveform segmentation processing performed by the waveform segmentation device 407. FIG. 4 shows a waveform template including the waveform X and the time section information Y.

The waveform segmentation device 407 scans the normal waveform with the waveform template and segments a partial waveform (a bold line portion in FIG. 4) of the normal waveform that matches the waveform template as a training waveform of a single door opening operation or a single door closing operation. For example, the waveform segmentation device 407 calculates as many absolute values of a difference between a given value constituting a start partial waveform of the waveform template and a given value constituting the normal waveform as the number of values constituting the start partial waveform. In addition, by determining a match when a sum of the absolute values is smaller than a predetermined threshold, a partial waveform with a time length indicated by the time section information Y from a time of day of beginning of the start partial waveform is segmented as a training waveform. By repeating this operation, one or a plurality of training waveforms are segmented for each of the operation patterns (for example, door opening and door closing).

The training waveform storage 408 stores the one or more segmented training waveforms for during door opening and during door closing.

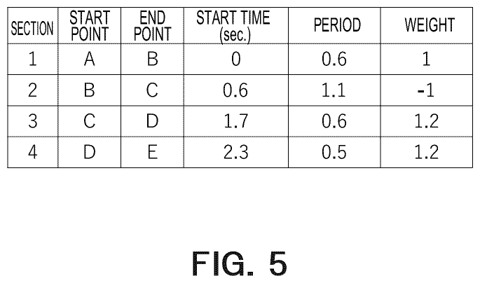

The transition data storage 409 stores, for each operation pattern, transition data regarding a transition of operations of the monitoring object 2. As shown in FIG. 5, the transition data includes information on feature points (start point, end point) during the operation of the monitoring object 2, a section, and a weight added to the section. The feature points (start point, end point) and the section correspond to information representing timings at which transitions of a plurality of operations take place. FIG. 5 shows transition data during door closing of the elevator door 2. The section is a time section between a feature point and another feature point. For example, a period of the section may have a width such as 0.5 to 0.7 seconds. The feature points may be determined based on a peak and/or an inflection point of a training waveform acquired in advance or may be designated by the user in advance based on an operation pattern or design considerations of the monitoring object 2.

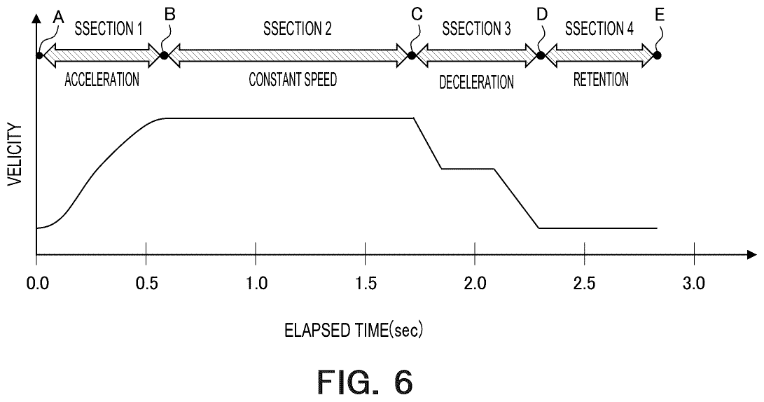

FIG. 6 is a diagram representing the example of transition data shown in FIG. 5 by another expression. A graph shown in FIG. 6 indicates a pattern (operation pattern) of a preset velocity pattern during door closing of the elevator door. Points A to E denote feature points of the operation of the elevator door (timings at which an operating state of the monitoring object 2 changes). Sections are depicted by double arrows. An example of feature points will be described with reference to FIGS. 5 and 6.
A: a time point at which the door is completely open and starts accelerating (a time point at which door closing is started)
B: a time point at which the door stops accelerating and transitions to constant speed
C: a time point at which the door ends its movement at constant speed and starts decelerating
D: a time point at which the door ends decelerating and stops
E: a time point at which a retention force is applied, and the door completely closes

The above are merely examples of feature points and the user may further additionally designate a feature point that the user considers important or may omit a feature point that the user does not consider important. An operation between the feature points A and B corresponds to an acceleration operation, an operation between the feature points B and C corresponds to a constant speed operation, an operation between the feature points C and D corresponds to a deceleration operation, and an operation between the feature points D and E corresponds to a retention operation.

A weight indicates, with respect to a given section, whether or not a specific anomaly can occur or a magnitude of a possibility of occurrence of the specific anomaly in the section. For example, while the weight of section 2 shown in FIG. 5 is −1, this represents the fact that, conceivably, an anomaly will not occur in the section 2 (in other words, the period during which an operation is performed at constant speed (refer to FIG. 6)). In addition, the weights of sections 3 and 4 being larger than section 1 represents the fact that an anomaly is more likely to occur in sections 3 and 4 than in section 1. Note that the description given above is only applied to the anomaly described above and other weights are to be added to each section with respect to an anomaly of another type. Accordingly, a normal waveform pattern generated from a section with a large weight is more likely to be selected by the model validator 415 to be described later.

The waveform divider 411 may specify, from a training waveform stored in the training waveform storage 408, a section in which the training waveform is less likely to fluctuate and reflect the low likelihood of fluctuation onto the weight of the section. Accordingly, for example, a section in which fluctuation is minimal and which is conceivably more suitable for anomaly detection can be used to generate a normal waveform pattern.

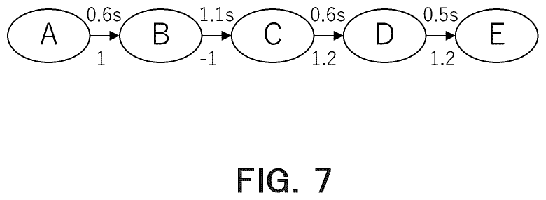

The graph generator 410 generates a transition graph based on transition data. The transition graph depicts a transition of feature points using nodes and links. FIG. 7 is an example of a transition graph during door closing generated by the graph generator 410 based on the transition data shown in FIG. 5. The transition graph shown in FIG. 7 represents the fact that, during door closing, an operation transitions in an order of feature points A, B, C, D, and E and the door closes.

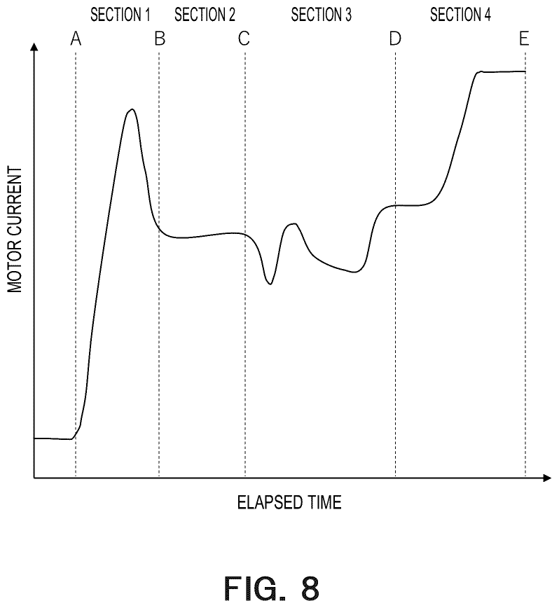

Based on a transition graph, the waveform divider 411 divides a training waveform as shown in FIG. 8. The waveform divider 411 may divide the training waveform by applying period information included in the transition graph to the training waveform. Alternatively, the waveform divider 411 may divide the training waveform by specifying a peak point and/or an inflection point from the training waveform and applying each feature point to each specified point. In this manner, the waveform divider 411 divides the training waveform by times of day that correspond to timings of transitions of a plurality of operations.

In addition, the waveform divider 411 adopts any one or more sections among a plurality of sections obtained by dividing the training waveform as an object section. The object section is to be constituted by a single section or a combination of two or more adjacent sections. However, sections with a weight of −1 are to be excluded. Hereinafter, for example, an object section constituted by a set including section 1 and section 2 will be represented as “section 1⋅2”. When weights are not taken into consideration, sections or combinations of sections that may be adopted as an object section are section 1, section 2, section 3, section 4, section 1⋅2, section 2⋅3, section 3⋅4, section 1⋅2⋅3, section 2⋅3⋅4, and section 1⋅2⋅3⋅4. However, since section 2 is known to have a weight of −1 (in other words, it is assumed that an anomaly will not occur) and need not be taken into consideration, section 2 is excluded from the object sections. Therefore, in reality, only section 1, section 3, section 4, and section 3⋅4 may be adopted as object sections. In other words, four object sections are acquired.

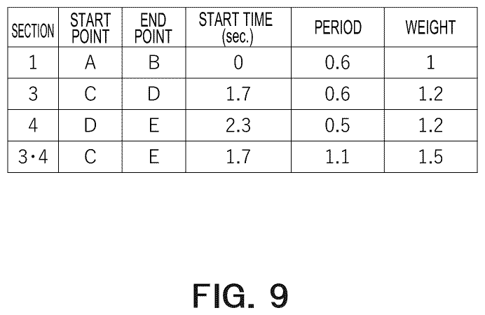

FIG. 9 shows object section detail data in which an acquired object section is associated with a start point, an end point, a start time of day, a period, and a weight. The weight of section 3⋅4 may be calculated using a formula determined in advance from weights of section 3 and section 4 or may be inputted by the user. The weight of section 3⋅4 is larger than the weights of section 3 and section 4.

The training parameter storage 412 stores a training parameter. The training parameter indicates a length of a normal waveform pattern that is extracted from a normal waveform of a single door opening operation or a single door closing operation. The length of the normal waveform pattern may be determined in accordance with a length of the object section to be an object of model generation or may be a specific value regardless of the length of the object section.

The model generator 413 generates, for each operation pattern, an estimation model (the second estimation model) related to a state of the monitoring object based on a partial waveform of the object section using one or more training waveforms. In the present embodiment, the second estimation model is a waveform pattern for determining a state of the monitoring object and, in particular, a waveform pattern (normal waveform pattern) generated from a training waveform in a normal state. For example, when the object sections are section 1, section 3, section 4, and section 3⋅4, a normal waveform pattern is generated with respect to each section from one or more training waveforms. A set of second estimation models generated with respect to the object sections corresponds to the first estimation model.

The model generator 413 generates the normal waveform patterns using, for example, OCLTS (One-Class Learning Time-series Shapelets). The model generator 413 may generate the normal waveform patterns using data mining or machine learning algorithms such as ROCLTS, one-class SVM, a nearest neighbor method, and MiniRocket.

The model validator 415 calculates a degree of similarity between a training waveform and a normal waveform pattern generated by the model generator 413. A degree of similarity is based on, for example, a distance between the normal waveform pattern and the training waveform. In the score calculator 420 and the anomaly detection device 422 to be described later, the higher the degree of similarity of a normal waveform pattern to be used, the higher the accuracy with which the state of the monitoring object 2 can be determined. Since a peak of a portion of a training waveform may slightly deviate forward or backward on a time axis, the model validator 415 may assess the normal waveform pattern using DTW (Dynamic Time Warping) to prevent the degree of similarity from deteriorating more than necessary even if the peak has deviated.

In addition, the model validator 415 determines whether or not an average degree of similarity calculated with respect to one or more training waveforms is equal to or higher than a threshold, stores a normal waveform pattern that is equal to or higher than a threshold in terms of the average degree of similarity in the model storage 414, and excludes a normal waveform pattern that is lower than the threshold in terms of the average degree of similarity. Statistics such as a maximum value, a minimum value, or dispersion of the degrees of similarity may be used instead of an average of the degrees of similarity.

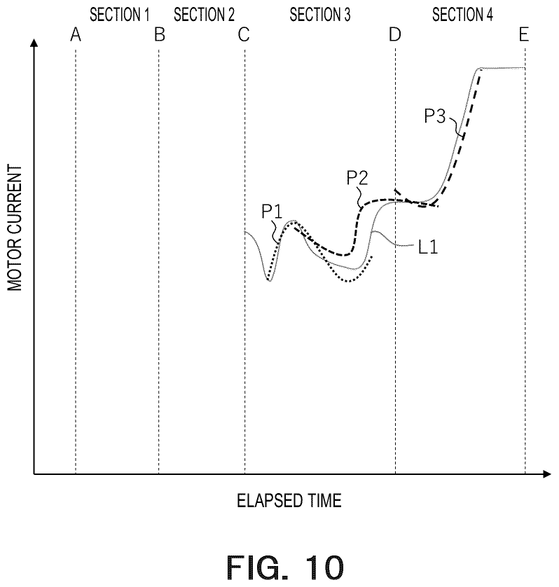

FIG. 10 is a diagram showing an example of a generated normal waveform pattern. A gray solid line L1 indicates a part of a training waveform (illustration of training waveform portions of section 1 and section 2 have been omitted for the sake of simplicity). FIG. 10 shows a case where a normal waveform pattern P1 is generated from section 3, a normal waveform pattern P2 is generated from section 3⋅4, and a normal waveform pattern P3 is generated from section 4. In this case, it is assumed that a normal waveform pattern generated with respect to section 1 has been excluded due to an average degree of similarity being lower than the threshold.

The model validator 415 may make a detection using a value obtained by multiplying a degree of similarity by a weight instead of using the degree of similarity itself. Accordingly, a normal waveform pattern in a waveform section in which an anomaly is more likely to occur can be used in a state detection of the monitoring object 2. For example, in the example shown in FIG. 10, since the weight of section 3⋅4 is larger than the weights of section 3 and section 4 (refer to FIG. 9), the normal waveform pattern P2 for section 3⋅4 is more readily used in the state detection of the monitoring object 2 as compared to the normal waveform pattern P1 for section 3 and the normal waveform pattern P3 for section 4.

As described above, the information processing apparatus 4 extracts a normal waveform pattern from a normal waveform. When performance of the sensor 3 is low, since fluctuation (dispersion) of each obtained training waveform increases, the number of training waveforms necessary for generating a normal waveform pattern increases and an amount of calculations also increases. However, by dividing training waveforms based on transition data and excluding sections in which an anomaly will not occur or an anomaly is assumed not to occur from objects of training, the amount of calculations can be significantly reduced.

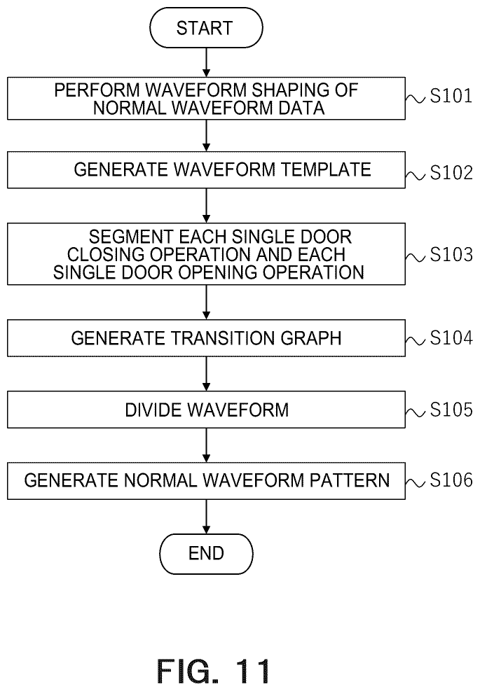

FIG. 11 is a flow chart showing an example of processing performed by the information processing apparatus 4 during training. Hereinafter, the processing performed by the information processing apparatus 4 during training will be described with reference to FIG. 11.

First, the waveform preprocessing device 402 performs waveform preprocessing of normal waveform data using a window function, a low-pass filter, or the like (step S101).

Next, the waveform template generator 405 generates a waveform template from a normal waveform after waveform preprocessing (step S102).

Next, the waveform segmentation device 407 segments a partial waveform of each single door opening operation and each single door closing operation from the normal waveform after the waveform preprocessing using the waveform template (step S103).

Next, the graph generator 410 generates a transition graph of the monitoring object 2 based on transition data (step S104).

Next, the waveform divider 411 divides the partial waveform for a single door opening operation and the partial waveform for a single door closing operation into a plurality of sections based on the transition graph (step S105).

Next, based on the divided sections, the model generator 413 generates a normal waveform pattern from the normal waveform (step S106).

As described above, the information processing apparatus 4 generates a normal waveform pattern during training.

Next, processing of the information processing apparatus 4 during a diagnosis will be described.

The sensor input device 400 stores monitoring waveform data which is numerical value data of a waveform (monitoring waveform or second waveform) to be a monitoring object and which is acquired by the sensor 3 in the monitoring waveform data storage 416. For example, the monitoring waveform data is acquired during a normal operation of the monitoring object 2.

The waveform preprocessing device 402 performs waveform preprocessing of a monitoring waveform. Waveform preprocessing includes processing of applying a low-pass filter while moving a window function with respect to the normal waveform data.

The preprocessed monitoring waveform storage 417 stores a monitoring waveform after waveform preprocessing.

The waveform segmentation device 407 segments a partial waveform of each single door opening operation and each single door closing operation of the elevator door using waveform templates from the monitoring waveform after waveform preprocessing.

The monitoring waveform storage 419 stores segmented monitoring waveforms.

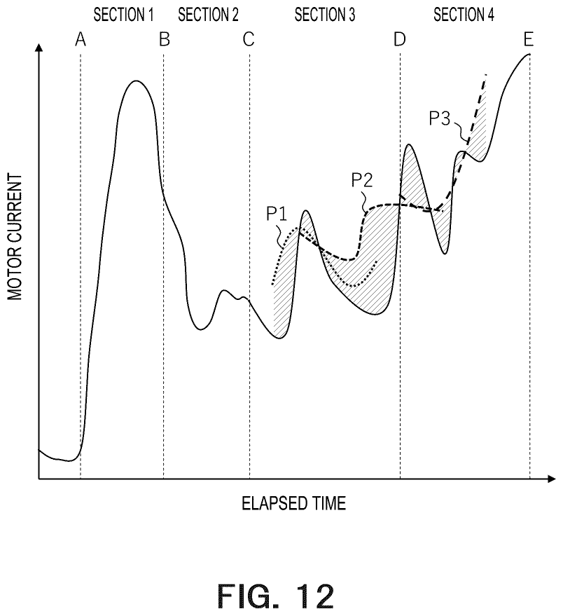

The score calculator 420 calculates a score indicating how much a segmented monitoring waveform deviates from the normal waveform pattern (a lowness of a degree of similarity between the segmented monitoring waveform and the normal waveform pattern). FIG. 12 is a diagram showing an example of a monitoring waveform and a normal waveform pattern. A score is, for example, a magnitude of the difference between the normal waveform pattern and the monitoring waveform or, in other words, an area of a region enclosed by the normal waveform pattern and the monitoring waveform (an area indicated by hatchings in FIG. 12). When there is an overlap between regions enclosed by the normal waveform pattern and the monitoring waveform, an area of the overlapping region may or may not be excluded from calculations.

The detection threshold storage 421 stores a threshold for detection (detection threshold) of the state of the monitoring object 2. There may be a plurality of detection thresholds. For example, a threshold for anomaly detection and a threshold for anomaly sign detection may be separately prepared.

The state judgement device 422 estimates the state of the monitoring object 2 based on the score calculated by the score calculator 420 and a detection threshold. In the present embodiment, a detection of whether nor not an anomaly or an anomaly sign is included in a monitoring waveform (whether or not the monitoring object 2 is in a normal state) is made. For example, it is determined that the monitoring waveform includes an anomaly sign when the calculated score is equal to or higher than a first detection threshold and lower than a second detection threshold and it is determined that the monitoring waveform includes an anomaly when the calculated score is equal to or higher than the second detection threshold. It is determined that the monitoring waveform includes neither an anomaly nor an anomaly sign when the score is lower than the first detection threshold.

The score calculator 420 may calculate a score for each normal waveform pattern. In this case, an anomaly or an anomaly sign of a monitoring waveform may be detected by making a detection based on a detection threshold for each normal waveform pattern and integrating detection results. For example, when it is determined that an anomaly is included in a monitoring waveform with respect to at least one normal waveform pattern, a result of the overall detection is to be that an anomaly is included in the monitoring waveform even though other normal waveform patterns are determined to include neither an anomaly nor an anomaly sign. For example, when it is determined that an anomaly sign is included in a monitoring waveform with respect to at least one normal waveform pattern, a result of the overall detection is to be that an anomaly sign is included in the monitoring waveform even though other normal waveform patterns are determined to include neither an anomaly nor an anomaly sign.

The output device 423 outputs a detection result of the state judgement device 422. When it is determined that an anomaly or an anomaly sign is included in a monitoring waveform, the output device 423 may display, as grounds of the detection, the monitoring waveform and a normal waveform pattern arranged at a corresponding position on the monitoring waveform (in other words, the diagram shown in FIG. 12) so as to be visible from the user in order to display a manner in which the monitoring waveform deviates from the normal waveform pattern.

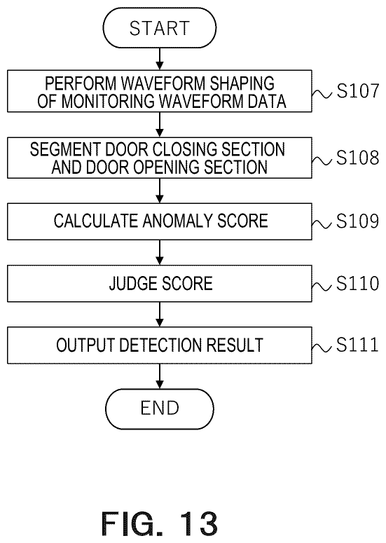

FIG. 13 is a flow chart showing an example of processing performed by the information processing apparatus 4 during a diagnosis. Hereinafter, the processing performed by the information processing apparatus 4 during a diagnosis will be described with reference to FIG. 13.

First, the waveform preprocessing device 402 performs waveform preprocessing of monitoring waveform data using a window function, a low-pass filter, or the like (step S107).

Next, the waveform segmentation device 407 segments a partial waveform of each single door opening operation and each single door closing operation from a monitoring waveform after the waveform preprocessing using the waveform template (step S108).

Next, the score calculator 420 calculates a score indicating a lowness of a degree of similarity between the segmented monitoring waveform and the normal waveform pattern (step S109).

Next, based on the calculated score, the state judgement device 422 determines whether or not an anomaly or an anomaly sign is included in the monitoring waveform (step S110).

Next, the output device 423 outputs a detection result (step S111).

As described above, the information processing apparatus 4 detects an anomaly or an anomaly sign during a diagnosis.

### First Modification

While the model generator 413 generates a set of normal waveform patterns as the first estimation model during training in the embodiment described above, a regression model such as a neural network may be generated instead. In this case, a partial waveform of each section in a training waveform and a weight of each section are used as training data. In addition, the regression model may be generated by setting a weight of training such that the larger the weight of a section, the higher the weight of training so that the larger the weight of a section, the higher the degree of similarity or the higher the score that is outputted when a partial waveform that is the same as or similar to the training waveform is inputted and, the smaller the weight of a section, the smaller an effect on the degree of similarity or the score to be outputted. A partial waveform of a section with a predetermined weight (for example, “−1”) may be ignored during training.

During a diagnosis, the waveform divider 411 may divide a monitoring waveform into a plurality of sections based on transition data and the score calculator 420 may input partial waveforms of the plurality of sections and weights of the plurality of sections into a regression model and acquire a degree of similarity or a score as an output.

The contents described in the present first modification are also valid in a second embodiment and a third embodiment to be described later.

### Second Modification

While a normal waveform pattern is generated as the second estimation model during training in the embodiment described above, a regression model such as a neural network may be generated as the second estimation model for each object section and a linear sum of the second estimation models may be adopted as the first estimation model. A ratio of a weight of each object section to a sum of weights of the object sections may be used as a weight of the linear sum. The second estimation model may be configured to receive a partial waveform of an object section as an input and output a degree of similarity or a score.

During a diagnosis, the waveform divider 411 may divide a monitoring waveform into a plurality of sections based on transition data and the score calculator 420 may input partial waveforms of an object section among the plurality of sections into a corresponding second estimation model in the first estimation model and acquire a degree of similarity or a score as an output of the first estimation model.

The contents described in the present second modification are also valid in the second embodiment and the third embodiment to be described later.

### Other Configuration Examples of Present Embodiment

A method in which the information processing apparatus 4 generates a normal waveform pattern and detects an anomaly or an anomaly sign has been described above. However, there may be cases where an operation, which is less frequent to occur and timings of occurrences are random, are included in operations of the monitoring object 2. Examples include, in an elevator door, an operation in which the door makes an (emergency) stop and then reopens when a part of a body of a passenger or the like comes into contact with the door when the door is closing. Since it is difficult to use such an operation for training, a normal waveform pattern cannot be appropriately generated when such an operation is mixed in a training waveform.

In consideration thereof, with respect to a training waveform including such an operation, a portion corresponding to the operation is prevented from being used based on a transition graph.

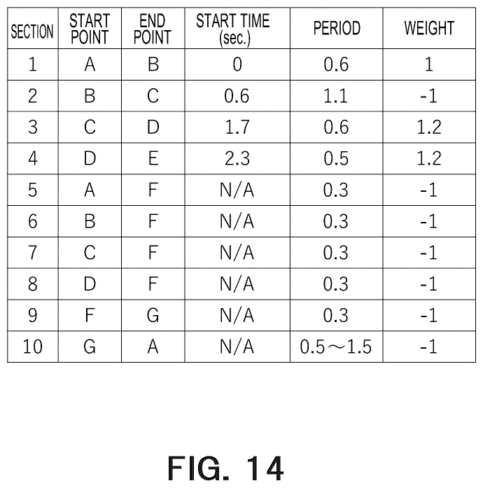

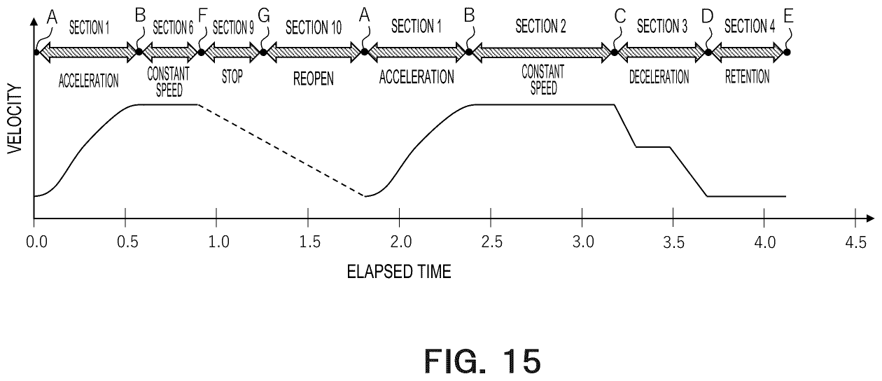

FIG. 14 shows transition data that takes reopening a door during door closing into consideration. FIG. 15 is a diagram showing another expression of the transition data shown in FIG. 14. Since a series of operations from stopping the door to reopening the door are complex, the series of operations are depicted by a dotted line for the sake of convenience. When reopening the door, feature points F and G are newly designated in addition to the feature points shown in FIGS. 5 and 6.
F: a time point at which the door stops
G: a time point at which the door starts to reopen

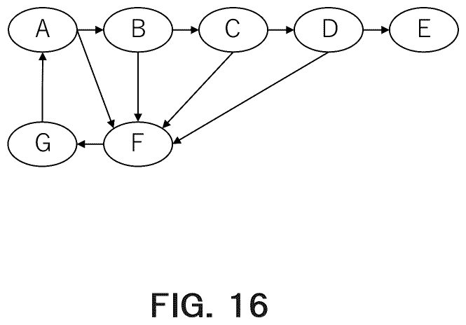

FIG. 16 is an example of a transition graph during door closing generated by the graph generator 410 based on the transition data shown in FIG. 14. In order to avoid complexity, period information and weight information are not illustrated. Since reopening may occur until the door is completely closed, transitions may occur from the feature points A to D to the feature point F.

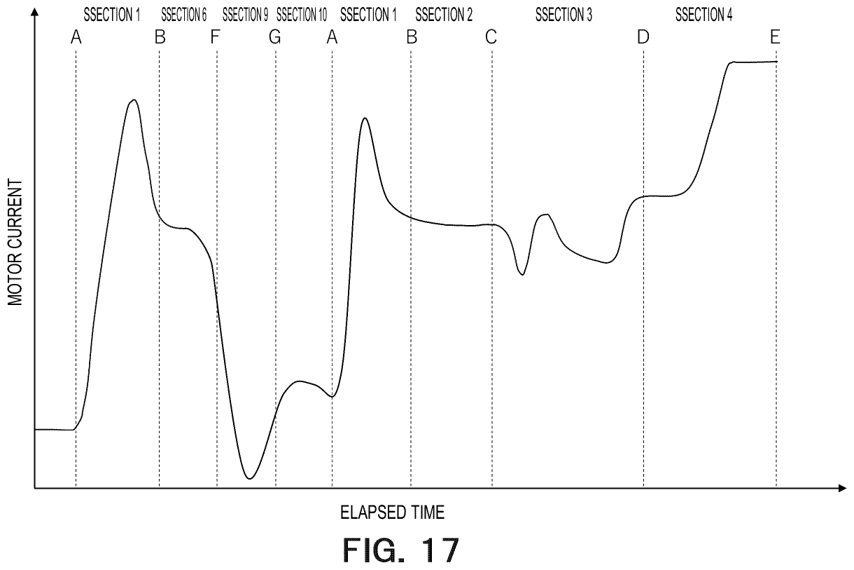

FIG. 17 shows an example of dividing, based on the transition graph shown in FIG. 16, a training waveform when reopening is to be performed. First, positions on a monitoring waveform that correspond to the feature points A, B, C, D, and E are specified in a similar manner when reopening does not occur.

In this case, from the transition graph shown in FIG. 16, when a reopening operation occurs, it is known that a transition is made to the feature point A via the feature points F and G regardless of the timing at which the reopening occurs. In other words, it is shown that reopening has occurred (the feature points F and G are present) before a second feature point A. In addition, as shown in FIG. 14, the weight is known to be −1 in all transitions from feature points A, B, C, and D to F, F to G, and G to A (sections 5 to 10). In other words, since it is known that reopening occurs before the second feature point A in the training waveform and that an anomaly will not occur during the reopening operation, a portion of the second feature point A and thereafter may be used for generating a normal waveform pattern.

In this manner, a waveform obtained by removing a waveform of a reopening operation among a training waveform can be used to generate a normal waveform pattern.

As described above, according to the first embodiment, by generating a normal waveform pattern by dividing a normal waveform into a plurality of sections using transition data and excluding sections in which an anomaly will not occur or an anomaly is assumed not to occur, the normal waveform pattern can be generated in an efficient manner even when using low-performance sensors. Using low-performance sensors enables cost reduction in state estimation (detection of an anomaly or an anomaly sign) to be realized even when there is a large number of maintenance object facilities.

### Modifications

A waveform during reopening is not used when generating a normal waveform pattern in the description given above. However, when there is a large number of waveforms during reopening that can be used to generate a normal waveform pattern, a training waveform (refer to FIG. 17) that includes a reopening operation may be used to generate a normal waveform pattern. In this case, the weight in the sections 5 to 10 may be changed from −1 to larger values.

### Second Embodiment

In the first embodiment, accurate state detection is realized by dividing a training waveform into a plurality of sections based on transition data and generating normal waveform patterns based on the sections.

In the second embodiment, instead of performing division of a training waveform, waveform preprocessing is optimized or quasi-optimized and a normal waveform pattern is generated from a training waveform obtained based on the optimized or quasi-optimized waveform preprocessing without performing waveform division. When waveform preprocessing is not appropriate, for example, an excess high-frequency component remains in a normal waveform after the waveform preprocessing and the high-frequency component ends up being added to the normal waveform pattern. By optimizing or quasi-optimizing waveform preprocessing and obtaining an appropriate training waveform, a normal waveform pattern capable of detecting an anomaly or an anomaly sign with high accuracy is obtained without having to divide the training waveform. Accordingly, detection of an anomaly or an anomaly sign using a simple sensor can be performed.

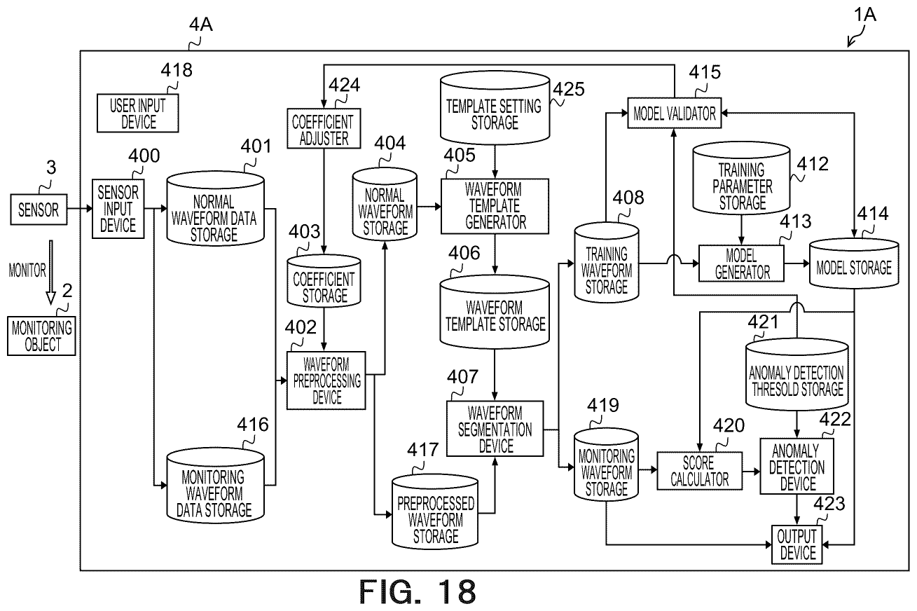

FIG. 18 is a block diagram of an information processing system 1A according to the second embodiment. Elements with a same name or a same function as the elements according to the first embodiment shown in FIG. 1 and described above will be denoted by same reference symbols. Hereinafter, descriptions will be omitted with the exception of changed or added items.

Compared to the information processing apparatus 4, an information processing apparatus 4A does not include the transition data storage 409, the graph generator 410, and the waveform divider 411 but includes a coefficient adjuster 424.

The model generator 413 generates a normal waveform pattern from one or more training waveforms. The model validator 415 calculates a score of the one or more training waveforms (in other words, a lowness of a degree of similarity between the one or more training waveforms and the normal waveform pattern) in a similar manner to the score calculator 420, performs a state detection of each training waveform based on a detection threshold in a similar manner to the state judgement device 422, and calculates an estimation accuracy (estimation accuracy of the first estimation model) of the normal waveform pattern. In the present embodiment, as an example, a false detection rate is calculated.

Since all training waveforms are waveforms in a normal state, as long as a normal waveform pattern is appropriately generated, an anomaly or an anomaly sign is not detected or the number of detected abnormalities or anomaly signs is small. In other words, the detection (false detection) of an anomaly or an anomaly sign by the model validator 415 at a certain or higher rate means that the normal waveform pattern has not been appropriately generated.

The coefficient adjuster 424 adjusts coefficients of a low-pass filter and the like used in waveform preprocessing based on the false detection rate calculated by the model validator 415. For example, a value of the coefficient of the low-pass filter is set in advance to a maximum value among settable values in the coefficient storage 403. When the false detection rate is equal to or higher than a threshold, the coefficient is reduced by a predetermined value. Adjustment of a coefficient is not limited to the low-pass filter and a coefficient of the window function may be adjusted (increased or reduced) or both coefficients may be adjusted.

Subsequently, in a similar manner to the first embodiment, the waveform preprocessing device 402, the waveform template generator 405, the waveform segmentation device 407, and the model generator 413 perform respective processing and once again generate a normal waveform pattern. In addition, the model validator 415 once again validates the normal waveform pattern.

The processing described above is repeated until the false detection rate drops below the threshold. Accordingly, an optimized or quasi-optimized normal waveform pattern is obtained.

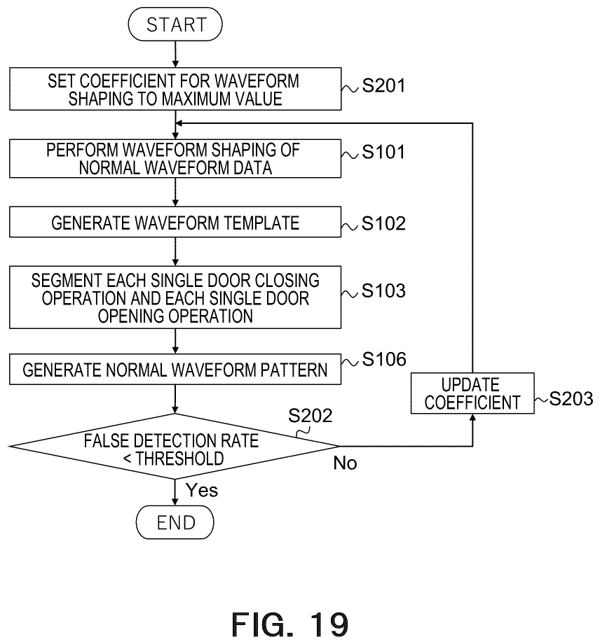

FIG. 19 is a flow chart showing an example of processing performed by the information processing apparatus 4A during training. Since processing during a diagnosis is similar to the processing in the first embodiment, a description thereof will be omitted. Hereinafter, the processing performed by the information processing apparatus 4A during training will be described with reference to FIG. 19.

First, the coefficient adjuster 424 sets the coefficient of the low-pass filter used in waveform preprocessing to a maximum value in a settable range (step S201).

Next, the information processing apparatus 4A performs processing of steps S101 to S103 and S106 in a similar manner to the first embodiment.

Next, the model validator 415 assesses the generated normal waveform pattern (step S202).

When the false detection rate is equal to or higher than the threshold, a transition is made to step S203 (step S202: No), the coefficient for waveform preprocessing is updated, and a return is made to step S101 (step S203).

When the false detection rate is lower than the threshold, the generated normal waveform pattern is outputted and the processing is ended (step S202: Yes).

While the coefficient of the low-pass filter has been updated, the coefficient of the window function of the low-pass filter may be updated. For example, every time the coefficient of the low-pass filter is updated, the coefficient of the window function is updated in a plurality of stages from a maximum value to a minimum value (or from a minimum value to a maximum value) and the normal waveform pattern is assessed for each updated value. When the false detection rate is equal to or higher than the threshold, the coefficient of the low-pass filter is further updated, the coefficient of the window function is updated in a plurality of stages from a maximum value to a minimum value (or from a minimum value to a maximum value), and the normal waveform pattern is assessed for each updated value. Thereafter, similar processing is repeated until the false detection rate drops below the threshold.

As described above, according to the second embodiment, waveform preprocessing can be optimized or quasi-optimized. Accordingly, an effective normal waveform pattern can be generated by using a simple sensor without performing waveform division. As a result, even when there is a large number of maintenance object facilities, cost reduction in the detection of an anomaly or an anomaly sign can be realized.

### Third Embodiment

The first embodiment and the second embodiment may be combined with each other. Combining waveform division with optimization of waveform preprocessing enables state detection to be performed with higher accuracy.

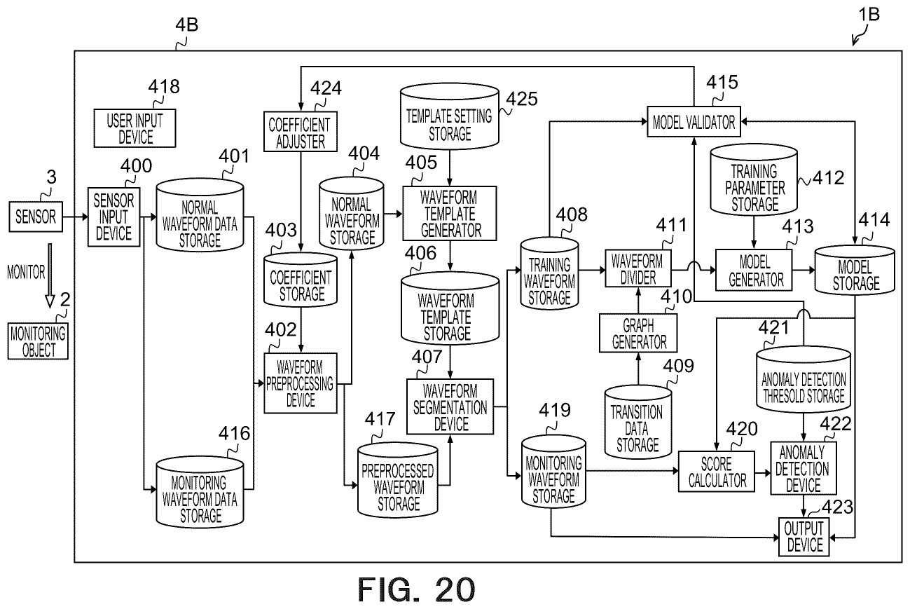

FIG. 20 is a block diagram of an information processing system 1B according to the third embodiment. Elements with a same name or a same function as the elements according to the first embodiment shown in FIG. 1 and described above will be denoted by same reference symbols. Hereinafter, descriptions will be omitted with the exception of changed or added items.

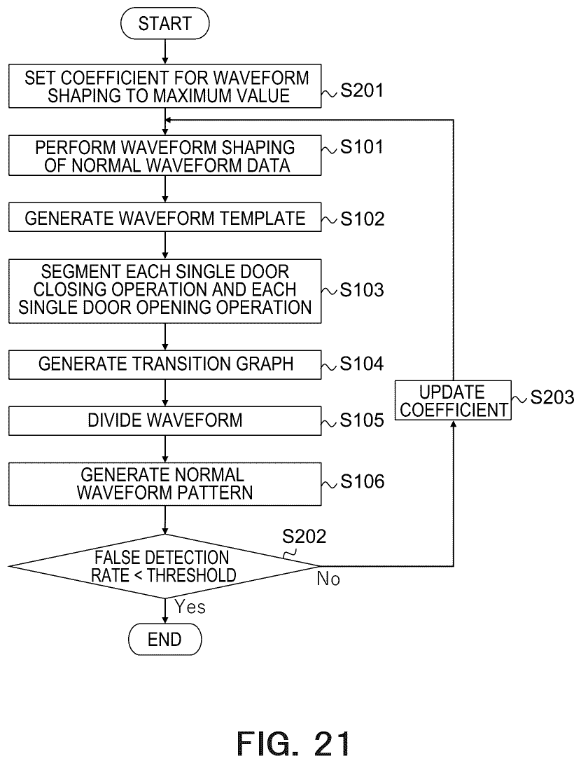

FIG. 21 is a flow chart showing an example of processing performed by an information processing apparatus 4B during training. Since processing during a diagnosis is similar to the processing in the first embodiment, a description thereof will be omitted. Hereinafter, the processing performed by the information processing apparatus 4B during training will be described with reference to FIG. 21.

First, the coefficient adjuster 424 sets the coefficient of the low-pass filter used in waveform preprocessing to a maximum value in a settable range (step S201).

Next, the information processing apparatus 4B performs processing of steps S101 to S106 in a similar manner to the first embodiment.

Next, the model validator 415 assesses the generated normal waveform pattern (step S202).

When the false detection rate is equal to or higher than the threshold, a transition is made to step S203 (step S202: No), the coefficient for waveform preprocessing is updated, and a return is made to step S101 (step S203).

When the false detection rate is lower than the threshold, the generated normal waveform pattern is outputted and the processing is ended (step S202: Yes).

The coefficient of the window function may also be considered an object of update in a similar manner to the second embodiment.

Combining division of a training waveform with optimization of waveform preprocessing enables a normal waveform pattern to be generated in a more efficient and effective manner. Accordingly, even when there is a large number of monitoring objects (maintenance object facilities), cost reduction in the detection of an anomaly or an anomaly sign can be realized.

### Hardware Configuration

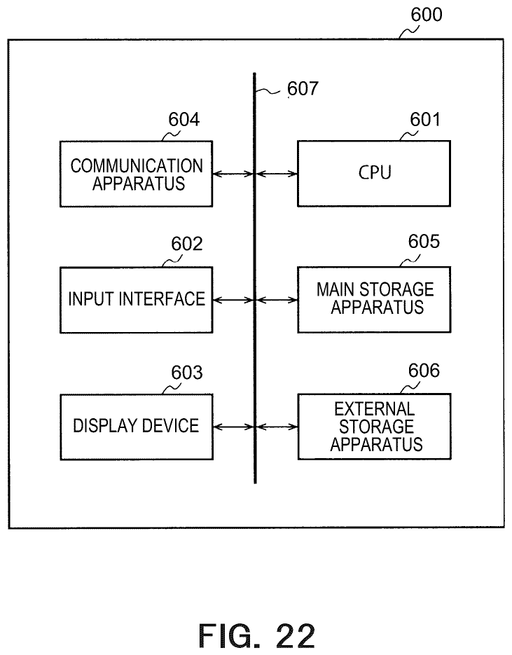

FIG. 22 illustrates a hardware configuration of the information processing device according to each embodiment. The information processing device is configured as a computer device 600. The computer device 600 includes a CPU 601, an input interface 602, a display device 603, a communication device 604, a main storage device 605, and an external storage device 606, and these components are mutually connected through a bus 607.

The CPU (central processing unit) 601 executes an information processing program as a computer program on the main storage device 605. The information processing program is a computer program configured to achieve each above-described functional composition of the present device. The information processing program may be achieved by a combination of a plurality of computer programs and scripts instead of one computer program. Each functional composition is achieved as the CPU 601 executes the information processing program.

The input interface 602 is a circuit for inputting, to the present device, an operation signal from an input device such as a keyboard, a mouse, or a touch panel. The input interface 602 corresponds to the input device in each embodiment.

The display device 603 displays data output from the present device. The display device 603 is, for example, a liquid crystal display (LCD), an organic electroluminescence display, a cathode-ray tube (CRT), or a plasma display (PDP) but is not limited thereto. Data output from the computer device 600 can be displayed on the display device 603. The display device 603 corresponds to the output device in each embodiment.

The communication device 604 is a circuit for the present device to communicate with an external device in a wireless or wired manner. Data can be input from the external device through the communication device 604. The data input from the external device can be stored in the main storage device 605 or the external storage device 606.

The main storage device 605 stores, for example, the information processing program, data necessary for execution of the information processing program, and data generated through execution of the information processing program. The information processing program is loaded and executed on the main storage device 605. The main storage device 605 is, for example, a RAM, a DRAM, or an SRAM but is not limited thereto. Each storage or database in the information processing device in each embodiment may be implemented on the main storage device 605.

The external storage device 606 stores, for example, the information processing program, data necessary for execution of the information processing program, and data generated through execution of the information processing program. The information processing program and the data are read onto the main storage device 605 at execution of the information processing program. The external storage device 606 is, for example, a hard disk, an optical disk, a flash memory, or a magnetic tape but is not limited thereto. Each storage or database in the information processing device in each embodiment may be implemented on the external storage device 606.

The information processing program may be installed on the computer device 600 in advance or may be stored in a storage medium such as a CD-ROM. Moreover, the information processing program in each embodiment may be uploaded on the Internet.

The present device may be configured as a single computer device 600 or may be configured as a system including a plurality of mutually connected computer devices 600.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The embodiments as described before may be configured as below.

### Clauses

Clause 1. An information processing apparatus, comprising
   processing circuitry configured to acquire transition data representing a transition of a plurality of operations of a monitoring object, divide, based the transition data, a first waveform of a sensor with respect to the monitoring object into a plurality of sections corresponding to the plurality of operations, and generate a first estimation model related to a state of the monitoring object based on partial waveforms of the plurality of sections in the first waveform.
Clause 2. The information processing apparatus according to clause 1, wherein
   a state of the monitoring object corresponding to the first waveform is a normal state, and
   the first estimation model is a model configured to estimate whether there is an anomaly or an anomaly sign in the monitoring object.
Clause 3. The information processing apparatus according to clause 1 or 2, wherein
   the transition data includes information representing timings at which the plurality of operations transition, and
   the processing circuitry is configured to divide the first waveform by times of day that correspond to timings of transitions of the plurality of operations.
Clause 4. The information processing apparatus according to any one of clauses 1 to 3, wherein
   the transition data includes weight information representing weights of the plurality of operations, and
   the processing circuitry is configured to select one or more sections from the plurality of sections based on the weight information and to generate the first estimation model based on the partial waveforms of the selected sections.
Clause 5. The information processing apparatus according to any one of clauses 1 to 4, wherein
   the processing circuitry is configured to estimate a state of the monitoring object based on a second waveform of the sensor of the monitoring object and on the first estimation model.
Clause 6. The information processing apparatus according to clause 5, wherein
   the processing circuitry is configured to generate a second estimation model related to a state of the monitoring object for each section, and
   the processing circuitry is configured to divide the second waveform into a plurality of sections corresponding to the plurality of operations based on the transition data and to estimate a state of the monitoring object based on a partial waveform for each section in the second waveform and on the second estimation model for each section.
Clause 7. The information processing apparatus according to clause 5 or 6, wherein
   the second estimation model is a waveform for detection of a state of the monitoring object, and
   the processing circuitry is configured to estimate a state of the monitoring object based on a degree of similarity between the partial waveform for each section in the second waveform and the second estimation model for each section.
Clause 8. The information processing apparatus according to clause 7, wherein
   the transition data includes weight information representing weights of the plurality of operations, and
   the degree of similarity is weighted according to the weight information and a state of the monitoring object is estimated based on the weighted degree of similarity.
Clause 9. The information processing apparatus according to clause 7 or 8, wherein
   the degree of similarity is based on an area of a region enclosed by the partial waveform for each section in the second waveform and a waveform for the detection for each section.
Clause 10. The information processing apparatus according to clause 9, wherein
   the processing circuitry is configured to calculate a score based on the degree of similarity for each section and to estimate a state of the monitoring object based on the score.
Clause 11. The information processing apparatus according to clause 10, wherein
   the processing circuitry is configured to determine that the monitoring object has an anomaly sign when the score is equal to or higher than a first detection threshold and lower than a second detection threshold and to determine that the monitoring object has an anomaly when the score is equal to or higher than the second detection threshold.
Clause 12. The information processing apparatus according to any one of clauses 1 to 11, wherein
   the processing circuitry is configured to perform waveform preprocessing of the first waveform based on a low-pass filter to remove a high-frequency component included in the first waveform, and to
   generate the first estimation model based on the first waveform after the waveform preprocessing.
Clause 13. The information processing apparatus according to clause 12, wherein
   a state of the monitoring object corresponding to the first waveform is a first state, and
   the processing circuitry is configured to estimate a state of the monitoring object based on the first waveform and the first estimation model, calculate an estimation accuracy of the first estimation model based on an estimation result, and update a coefficient of the low-pass filter based on the estimation accuracy.
Clause 14. The information processing apparatus according to clause 13, wherein
   the processing circuitry is configured to perform the waveform preprocessing further based on a window function of the low-pass filter, and to
   further update a coefficient of the window function based on the estimation accuracy.
Clause 15. The information processing apparatus according to any one of clauses 1 to 14, wherein
   the processing circuitry is configured to generate the first estimation model based on data mining or machine learning.
Clause 16. The information processing apparatus according to any one of clauses 1 to 15, wherein
   the monitoring object is an elevator.
Clause 17. The information processing apparatus according to clause 16, wherein
   the sensor is a sensor configured to detect a current value of a motor configured to open and close a door of the elevator.
Clause 18. The information processing apparatus according to clause 16 or 17, wherein
   the plurality of operations of the monitoring object include an acceleration operation, a constant speed operation, a deceleration operation, and a retention operation of the door of the elevator.
Clause 19. The information processing apparatus according to any one of clauses 1 to 18, wherein
   the processing circuitry is configured to control the monitoring object based on an estimated state of the monitoring object.
Clause 20. An information processing apparatus, comprising processing circuitry configured to:
   perform waveform preprocessing of a first waveform of a sensor with respect to a monitoring object in a first state based on a low-pass filter to remove a high-frequency component included in the first waveform;
   generate a first estimation model related to a state of the monitoring object based on the first waveform after the waveform preprocessing; and
   estimate a state of the monitoring object based on the first waveform and the first estimation model, calculate an accuracy of the first estimation model based on an estimation result, and update a coefficient of the low-pass filter based on the accuracy of the first estimation model.
Clause 21. An information processing method, comprising
   acquiring transition data representing a transition of a plurality of operations of a monitoring object;
   dividing, based the transition data, a first waveform of a sensor with respect to the monitoring object into a plurality of sections corresponding to the plurality of operations; and
   generating a first estimation model related to a state of the monitoring object based on partial waveforms of the plurality of sections in the first waveform.
Clause 22. A non-transitory computer readable medium having a computer program stored therein which causes a computer to performs processes, comprising
   acquiring transition data representing a transition of a plurality of operations of a monitoring object;
   dividing, based the transition data, a first waveform of a sensor with respect to the monitoring object into a plurality of sections corresponding to the plurality of operations; and
   generating a first estimation model related to a state of the monitoring object based on partial waveforms of the plurality of sections in the first waveform.

1. An information processing apparatus, comprising
processing circuitry configured to acquire transition data representing a transition of a plurality of operations of a monitoring object,
divide, based the transition data, a first waveform of a sensor with respect to the monitoring object into a plurality of sections corresponding to the plurality of operations, and
generate a first estimation model related to a state of the monitoring object based on partial waveforms of the plurality of sections in the first waveform.

2. The information processing apparatus according to claim 1, wherein
a state of the monitoring object corresponding to the first waveform is a normal state, and
the first estimation model is a model configured to estimate whether there is an anomaly or an anomaly sign in the monitoring object.

3. The information processing apparatus according to claim 1, wherein
the transition data includes information representing timings at which the plurality of operations transition, and
the processing circuitry is configured to divide the first waveform by times of day that correspond to timings of transitions of the plurality of operations.

4. The information processing apparatus according to claim 1, wherein
the transition data includes weight information representing weights of the plurality of operations, and
the processing circuitry is configured to select one or more sections from the plurality of sections based on the weight information and to generate the first estimation model based on the partial waveforms of the selected sections.

5. The information processing apparatus according to claim 1, wherein
the processing circuitry is configured to estimate a state of the monitoring object based on a second waveform of the sensor of the monitoring object and on the first estimation model.

6. The information processing apparatus according to claim 5, wherein
the processing circuitry is configured to generate a second estimation model related to a state of the monitoring object for each section, and
the processing circuitry is configured to divide the second waveform into a plurality of sections corresponding to the plurality of operations based on the transition data and to estimate a state of the monitoring object based on a partial waveform for each section in the second waveform and on the second estimation model for each section.

7. The information processing apparatus according to claim 5, wherein
the second estimation model is a waveform for detection of a state of the monitoring object, and
the processing circuitry is configured to estimate a state of the monitoring object based on a degree of similarity between the partial waveform for each section in the second waveform and the second estimation model for each section.

8. The information processing apparatus according to claim 7, wherein
the transition data includes weight information representing weights of the plurality of operations, and
the degree of similarity is weighted according to the weight information and a state of the monitoring object is estimated based on the weighted degree of similarity.

9. The information processing apparatus according to claim 7, wherein
the degree of similarity is based on an area of a region enclosed by the partial waveform for each section in the second waveform and a waveform for the detection for each section.

10. The information processing apparatus according to claim 9, wherein
the processing circuitry is configured to calculate a score based on the degree of similarity for each section and to estimate a state of the monitoring object based on the score.

11. The information processing apparatus according to claim 10, wherein
the processing circuitry is configured to determine that the monitoring object has an anomaly sign when the score is equal to or higher than a first detection threshold and lower than a second detection threshold and to determine that the monitoring object has an anomaly when the score is equal to or higher than the second detection threshold.

12. The information processing apparatus according to claim 1, wherein
the processing circuitry is configured to perform waveform preprocessing of the first waveform based on a low-pass filter to remove a high-frequency component included in the first waveform, and to
generate the first estimation model based on the first waveform after the waveform preprocessing.

13. The information processing apparatus according to claim 12, wherein
a state of the monitoring object corresponding to the first waveform is a first state, and
the processing circuitry is configured to estimate a state of the monitoring object based on the first waveform and the first estimation model, calculate an estimation accuracy of the first estimation model based on an estimation result, and update a coefficient of the low-pass filter based on the estimation accuracy.

14. The information processing apparatus according to claim 13, wherein
the processing circuitry is configured to perform the waveform preprocessing further based on a window function of the low-pass filter, and to
further update a coefficient of the window function based on the estimation accuracy.

15. The information processing apparatus according to claim 1, wherein
the processing circuitry is configured to generate the first estimation model based on data mining or machine learning.

16. The information processing apparatus according to claim 1, wherein
the monitoring object is an elevator.

17. The information processing apparatus according to claim 16, wherein
the sensor is a sensor configured to detect a current value of a motor configured to open and close a door of the elevator.

18. The information processing apparatus according to claim 16, wherein
the plurality of operations of the monitoring object include an acceleration operation, a constant speed operation, a deceleration operation, and a retention operation of the door of the elevator.

19. The information processing apparatus according to claim 1, wherein
the processing circuitry is configured to control the monitoring object based on an estimated state of the monitoring object.

20. An information processing apparatus, comprising
processing circuitry configured to:
perform waveform preprocessing of a first waveform of a sensor with respect to a monitoring object in a first state based on a low-pass filter to remove a high-frequency component included in the first waveform;
generate a first estimation model related to a state of the monitoring object based on the first waveform after the waveform preprocessing; and
estimate a state of the monitoring object based on the first waveform and the first estimation model, calculate an accuracy of the first estimation model based on an estimation result, and update a coefficient of the low-pass filter based on the accuracy of the first estimation model.

21. An information processing method, comprising
acquiring transition data representing a transition of a plurality of operations of a monitoring object;
dividing, based the transition data, a first waveform of a sensor with respect to the monitoring object into a plurality of sections corresponding to the plurality of operations; and
generating a first estimation model related to a state of the monitoring object based on partial waveforms of the plurality of sections in the first waveform.

22. A non-transitory computer readable medium having a computer program stored therein which causes a computer to performs processes, comprising
acquiring transition data representing a transition of a plurality of operations of a monitoring object;
dividing, based the transition data, a first waveform of a sensor with respect to the monitoring object into a plurality of sections corresponding to the plurality of operations; and
generating a first estimation model related to a state of the monitoring object based on partial waveforms of the plurality of sections in the first waveform.
